(19) United States
(12) Patent Application Publication
(10) Pub. No.: US 2015/0245740 A1
(43) Pub. Date: Sep. 3, 2015

(54) COOKING APPARATUS

(71) Applicant: Gaucho Garcia LLC, Morgan Hill, CA (US)

(72) Inventor: Gabriel Garcia, Morgan Hill, CA (US)

(73) Assignee: Gaucho Garcia LLC, Morgan Hill, CA (US)

(21) Appl. No.: 14/195,720

(22) Filed: Mar. 3, 2014

(51) Int. Cl. A47J 37/07

(52) U.S. Cl. CPC A47J 37/0704; A47J 37/079; A47J 2037/0795

(57) ABSTRACT

Provided herein is an apparatus including a grill unit for cooking food including a grill firebox and a grill positioned substantially over the grill firebox; and a fuel-preparing unit for preparing fuel including a chute configured to aggregate and transfer prepared fuel to the grill firebox, wherein the fuel-preparing unit is removably attached outboard of the grill unit.

### BACKGROUND

Apparatuses typically used for outdoor cooking, which are often referred to as barbecue grills or simply barbecues or grills, enable convenient cooking of food in nearly any outdoor location. These types of apparatuses for cooking thereon are popular the world over for a number of reasons and have gathered a number of devotees.

### SUMMARY

Provided herein is an apparatus including a grill unit for cooking food including a grill firebox and a grill positioned substantially over the grill firebox; and a fuel-preparing unit for preparing fuel including a chute configured to aggregate and transfer prepared fuel to the grill firebox, wherein the fuel-preparing unit is removably attached outboard of the grill unit.

These and other features of the claimed invention may be better understood with reference to the following drawings, description, and appended claims.

### BRIEF DESCRIPTION OF DRAWINGS

FIG. 1 shows a first view of an apparatus in accordance with some embodiments.

FIGS. 2A-2C show two views of the apparatus including a grill unit portion in accordance with some embodiments.

FIGS. 3A-3C show the apparatus including a fuel-preparing unit in accordance with some embodiments.

FIGS. 4A-4E show apparatuses in accordance with some embodiments having a fuel transfer mechanism between the grill unit and the fuel-preparing unit.

FIGS. 5A-5B show apparatuses in accordance with some embodiments having a fuel transfer mechanism between the grill unit and the fuel-preparing unit.

### DESCRIPTION

Before some particular embodiments are illustrated and/or described in greater detail, it should be understood by persons having ordinary skill in the art that the particular embodiments provided herein do not limit the scope of the claimed invention, as features of such particular embodiments may vary. It should likewise be understood that a particular embodiment provided herein has one or more features that may be readily separated from the particular embodiment and optionally combined with or substituted for one or more features of any of a number of other embodiments illustrated and/or described herein.

It should also be understood by persons having ordinary skill in the art that the terminology used herein is for the purpose of describing some particular embodiments, and the terminology does not limit the scope of the claimed invention. Unless indicated otherwise, ordinal numbers (e.g., first, second, third, etc.) are used to distinguish or identify different features or steps in a group of features or steps and do not supply a serial or numerical limitation. For example, “first,” “second,” and “third” features or steps need not necessarily appear in that order, and the particular embodiments need not necessarily be limited to the three features or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” or the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

Unless defined otherwise, all technical and scientific terms used herein have the same meaning as commonly understood by persons of ordinary skill in the art.

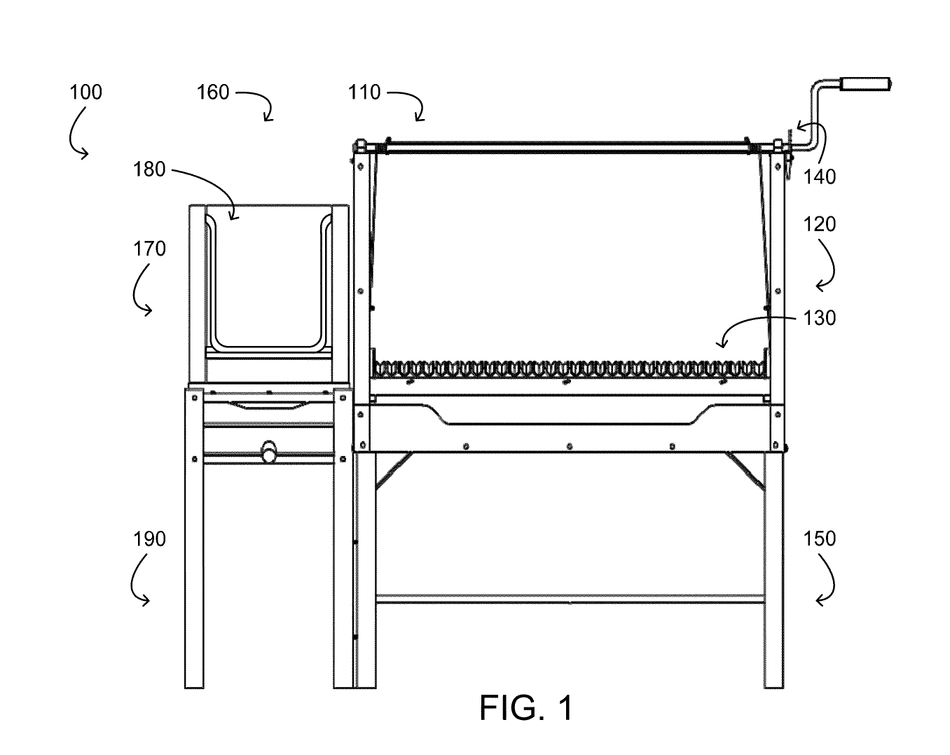

FIGS. 1, 2A, 2B, 3A, and 3B show different views of an apparatus for cooking according to some embodiments. It should be understood that the apparatus of FIGS. 1, 2A, 2B, 3A, and 3B are not intended to limit the scope of the claimed invention provided herein.

As illustrated in FIG. 1, an apparatus 100 for cooking (e.g., grilling, smoking, etc.) may include a grill unit 110 and a fuel-preparing unit 160. The grill unit 110 and/or the fuel-preparing unit 160 may be configured for removably attaching the fuel-preparing unit 160 outboard of the grill unit 110. Removably attaching the fuel-preparing unit 160 outboard of the grill unit 110 includes, but is not limited to, attaching the fuel-preparing unit 160 to the grill unit 110 using interlocking tabs and/or fasteners (e.g., screws, nuts and bolts, rivets, etc.). Such a design allows for an increase in grill unit 110 size due to not including the fuel-preparing unit 160 in the grill unit 110 or inboard of the grill unit 110.

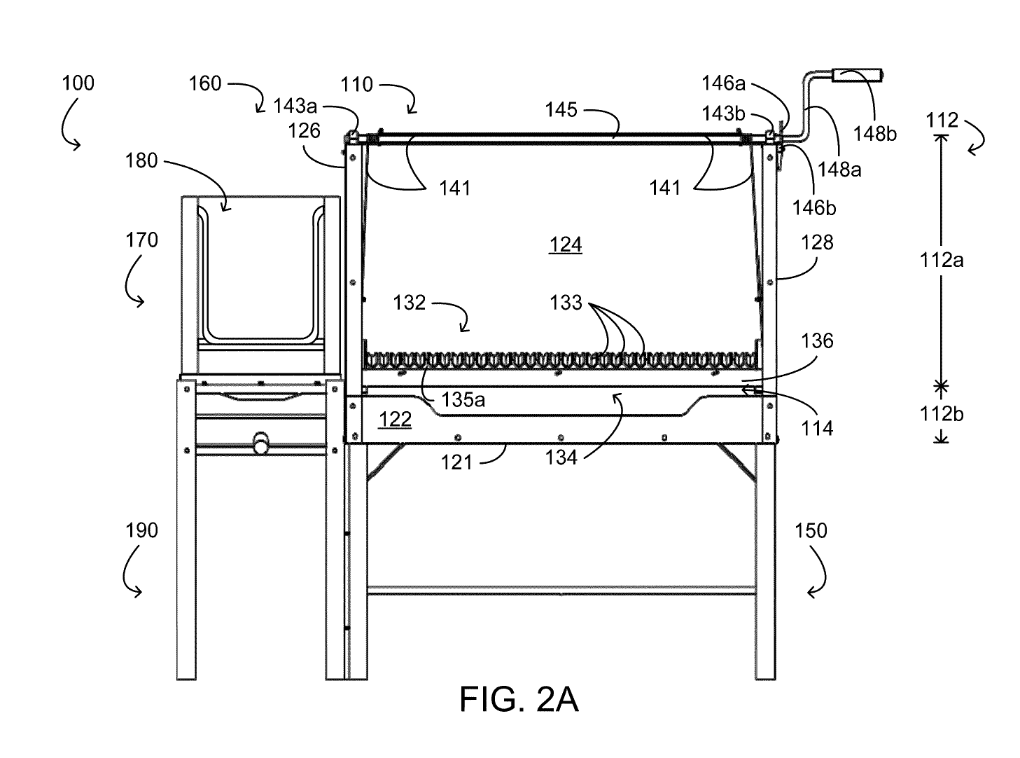

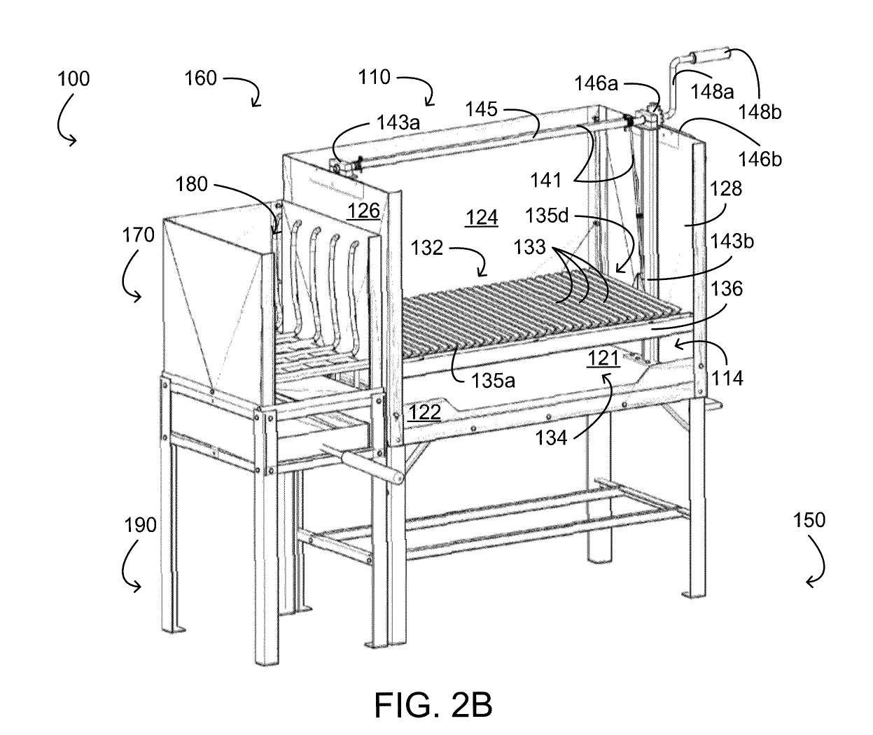

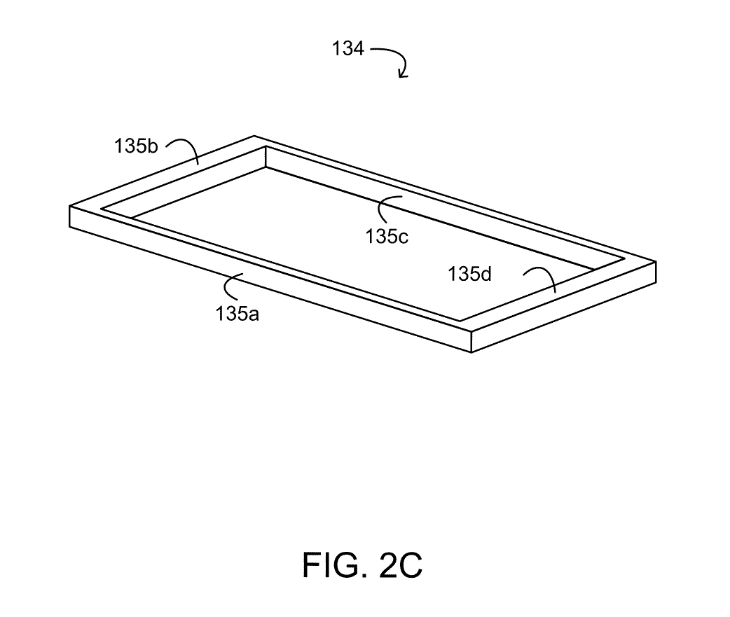

The grill unit 110 may include, but is not limited to, a grill unit housing 120, a grill 130, and a windlass 140. The grill 130 may be removably attached to the windlass 140 for raising or lowering the grill 130 in order to control the amount of heat for cooking food. Removably attaching the grill 130 to the windlass 140 includes, but is not limited to, hooking the grill 130 to the windlass 140 using one or more cables or chains 141 from the windlass terminating with hooks. The grill unit 110 may further include a grill unit support structure 150 configured to support the grill unit 110. As illustrated in FIGS. 2A and 2B, the grill unit support structure 150 may include a set of legs. Any pair or pairs of legs in the set of legs may be cross-braced to reinforce the grill unit support structure 150. Although the grill unit 110 is illustrated to have a particular grill unit support structure 150, the particular grill unit support structure 150 illustrated in FIGS. 1, 2A, 2B, 3A, and 3B are not intended to be limiting. For example, the apparatus 100 may be configured to be freestanding, portable, or mobile, and the grill unit 110 may include a grill unit support structure 150 including wheels, runners, or the like. For another example, the apparatus 100 may be configured to be immobile or permanent, and the grill unit 110 may include a grill unit support structure 150 including a masonry unit or the like.

The grill unit 110 may include a front, wherein the front of the grill unit 110 is closest to an operator while the operator customarily cooks on the grill unit 110. The grill unit 110 may also include a back, wherein the back of the grill unit 110 is opposite the front of the grill unit 110 and/or farthest from the operator while the operator customarily cooks on the grill unit 110. The grill unit 110 may also include a first side, wherein the first side of the grill unit 110 nominally is the side of the grill unit 110 to which the fuel-preparing unit 160 is attached. The grill unit 110 may also include a second side, wherein the second side of the grill unit 110 nominally is the side of the grill unit 110 opposite the first side of the grill unit 110 and/or to which the fuel-preparing unit 160 is not attached.

The fuel-preparing unit 160 may include, but is not limited to, a fuel-preparing unit housing 170 and a grate 180. The grate 180 may freely stand within the fuel-preparing unit housing 170. However, it is appreciated that the grate 180 may be supported by the fuel-preparing unit housing 170 or a component therein. The fuel-preparing unit 160 may be configured to prepare fuel including embers derived from a fuel source selected from wood, lump charcoal, charcoal briquettes, extruded charcoal, and combinations thereof.

Referring now to FIGS. 2A and 2B the apparatus including the grill unit in accordance with some embodiments are shown. The grill unit 110 may include a vertical space 112 partitioned into a grill space 112a and a grill firebox space 112b. The grill firebox space 112b corresponds to a grill firebox 114 reserved for cooking fuel such as prepared fuel (e.g., embers) and the grill space 112a is reserved for a grill (e.g., the grill 130).

The grill unit housing 120, as shown in FIGS. 2A and 2B, may include, but is not limited to, at least a bottom 121 that may coincide with a bottom of the grill firebox 114. The grill unit housing 120 may also include a front wall 122 to cover a substantial portion of the grill firebox space 112b or the entire grill firebox space at the front of the grill unit 110, leaving the grill space 112a open to the operator. According to one embodiment, the front wall 122 may include a cut-out portion for allowing easy access to the grill firebox 114 and/or contents thereof while safely containing the contents of the grill firebox 114. The grill unit housing 120 may also include a back wall 124, wherein the back wall 124 that may substantially cover the entire grill firebox space 112b. The back wall 124 may also cover a substantial portion of the grill space 112a or the entire grill space 112a at the back of the grill unit 110.

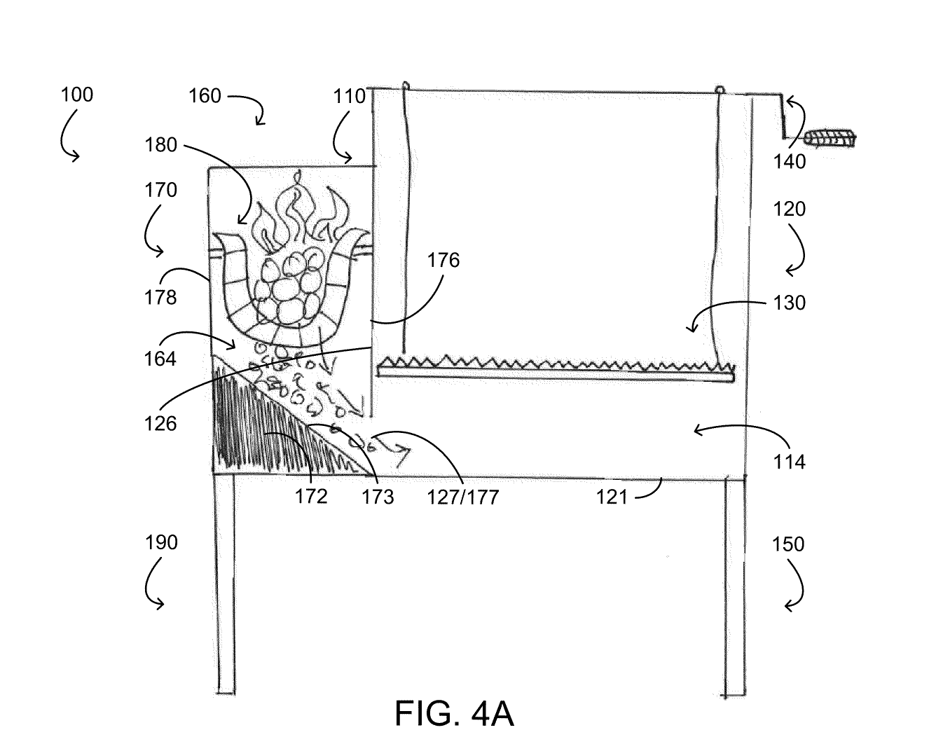

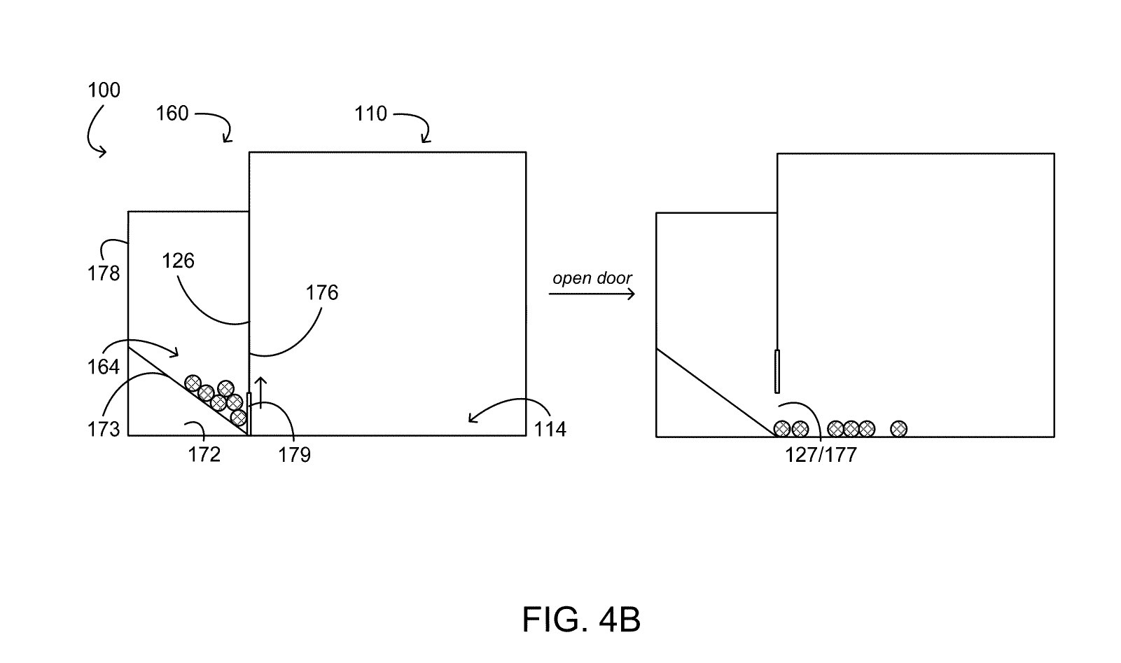

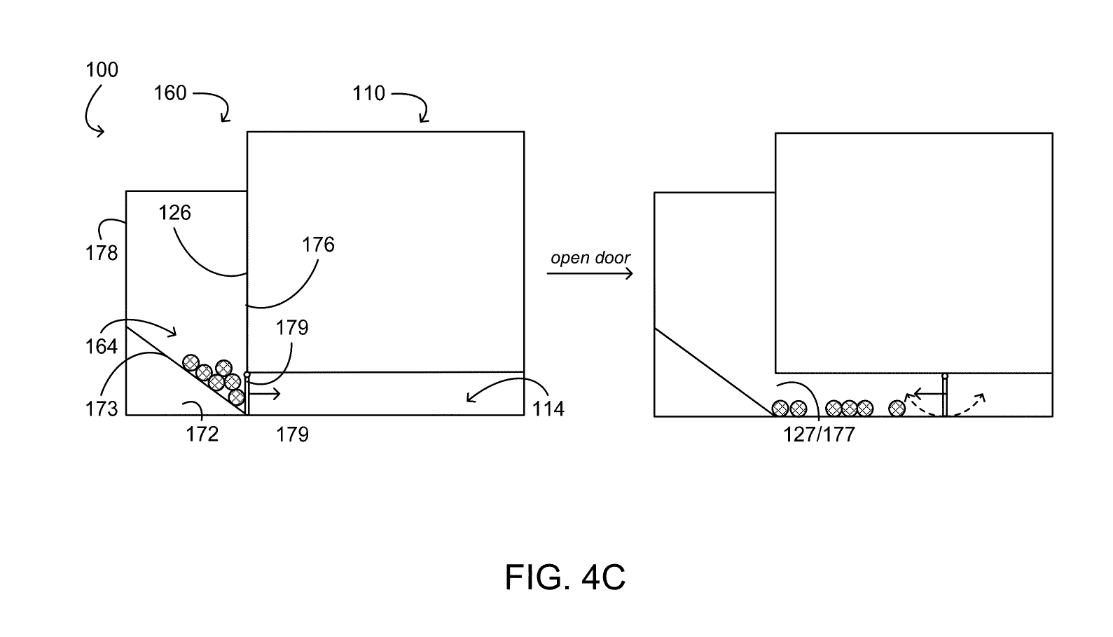

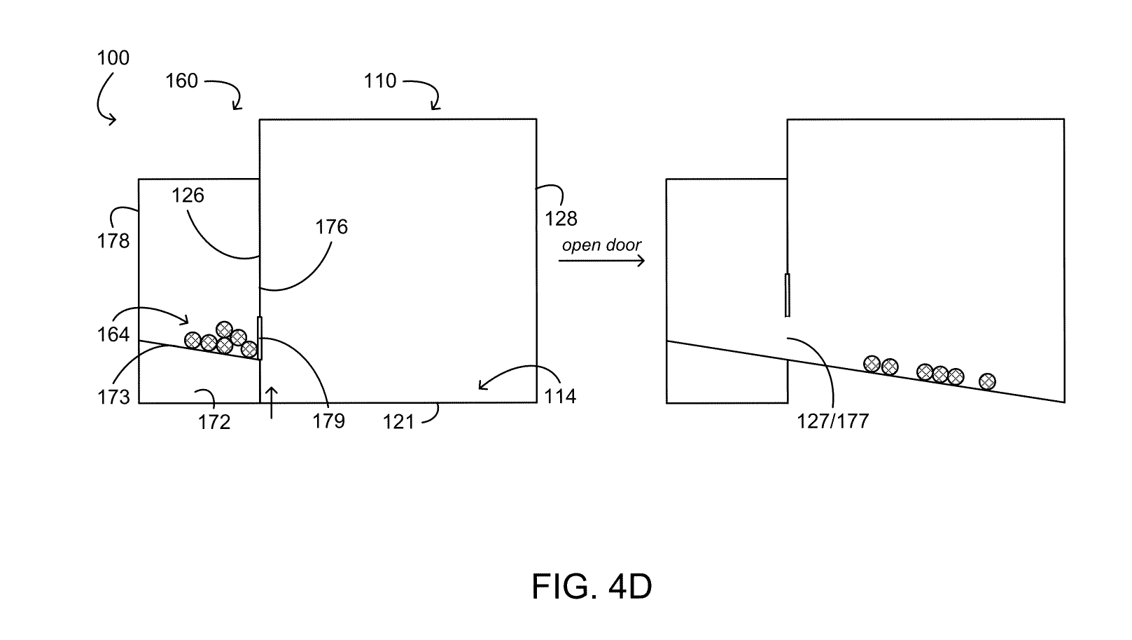

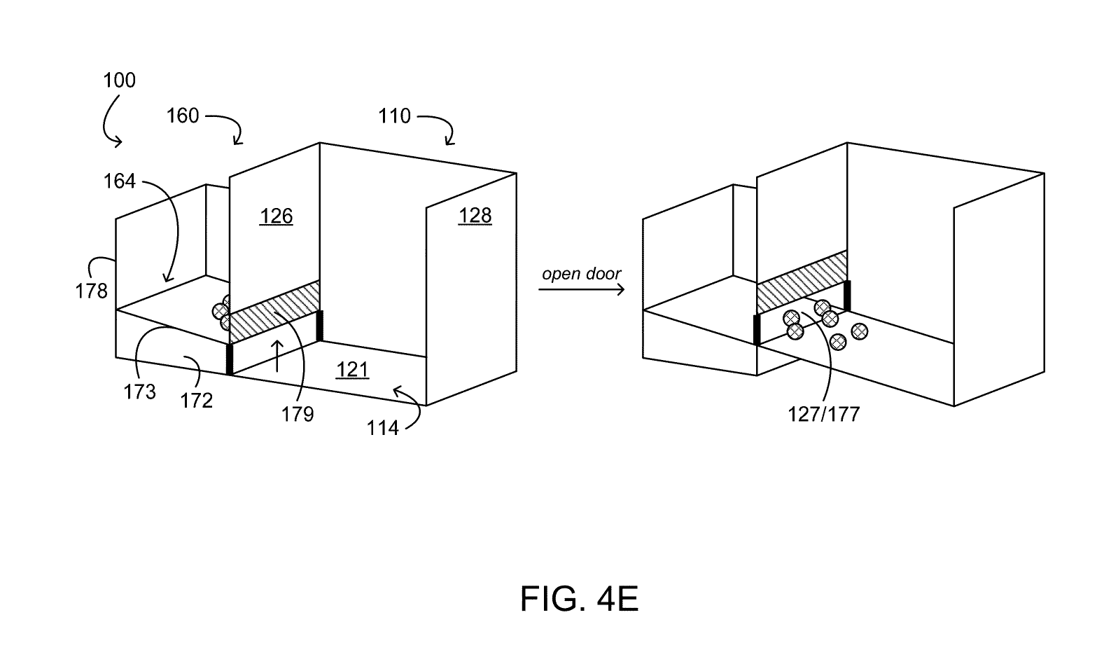

The grill unit housing 120 may also include a first sidewall 126, wherein the first sidewall 126 may cover a substantial portion of the grill firebox space 112b or the entire grill firebox space 112b. For example, FIG. 4A illustrates the first sidewall 126 covering a substantial portion of the grill firebox space 112b, wherein the first sidewall 126 includes an opening 127 allowing transfer of the prepared fuel directly to the grill firebox 114. The first sidewall 126 may also cover a substantial portion of the grill space 112a or the entire grill space 112a at the first side of the grill unit 110. The grill unit housing 120 may also include a second sidewall 128 that may cover a substantial portion of the grill firebox space 112b or the entire grill firebox space 112b. The second sidewall 128 may also cover a substantial portion of the grill space 112a or the entire grill space 112a at the second side of the grill unit 110. Leaving the grill space 112a open at the front of the grill unit 110 and closing the grill space 112a off elsewhere allows easy access to the grill space 112a while a) reducing or eliminating environmental factors such as wind, which may otherwise lead to convective heat loss from the grill space 112a; b) radiating heat back into the grill space 112a, which may establish a spatial and/or temporal thermal equilibrium in the grill space 112a; and/or c) protecting non-operators or passersby. It is appreciated that the grill unit housing 120 may also include a door (not shown) that may be closed to close off the opening at the front of the grill unit 110, as desired during cooking, or it may be left open, as desired.

In some embodiments, the grill unit housing 120, including one or more of the bottom 121, the front wall 122, the back wall 124, the first sidewall 126, and the second sidewall 128, may be adjustable such that the size of the grill unit housing 120 may be adjusted to one or more predetermined sizes. For example, in some embodiments, the back wall 124, the first sidewall 126, and the second sidewall 128 may each include two or more interleaved panels with interlocking tabs and slots at predetermined positions for adjusting the height of the back wall 124, the first sidewall 126, and the second sidewall 128 to the one or more predetermined sizes. For example, in some embodiments, the bottom 121, the front wall 122, the back wall 124, the first sidewall 126, and the second sidewall 128, may each include two or more interleaved panels with interlocking tabs and slots at predetermined positions for adjusting the bottom 121, the front wall 122, the back wall 124, the first sidewall 126, and the second sidewall 128 in a longitudinal and/or latitudinal dimension to the one or more predetermined sizes. Grills (e.g., the grill 130) of predetermined sizes may be used in accordance with the foregoing predetermined sizes of the grill unit housing 120.

The grill 130, as shown in FIGS. 2A and 2B, may include, but is not limited to, a grill surface 132, a grill understructure 134, and a drip pan 136, as shown in FIGS. 2A and 2B. The grill understructure 134 is described in greater detail with respect to FIG. 2C. The grill surface 132 may be fixedly attached (e.g., welded) to the grill understructure 134, and wherein the drip pan 136 may be removably attached (e.g., set on hooks, pins, screws, bolts, etc.) to the grill understructure 134. The grill 130 may be configured with a slight slope from the back of the grill unit 110 down to the front of the grill unit 110 to convey drippings from grilling food to the drip pan 136.

The grill surface 132 may include, but is not limited to, a number of “V”-shaped latitudinal or elongate members 133 (e.g., a first elongate member 133a, a second elongate member 133b, . . . , an n^{th} elongate member 133n, wherein n indicates the n^{th} elongate member). Elongated members 133 may be configured to a) retain heat (e.g., iron, such as wrought iron or cast iron; steel, such as stainless steel; etc.); b) resist rust (e.g., rust-preventing coating on iron; stainless steel; etc.); and/or convey drippings from grilling food to the drip pan 136. Each of the number of “V”-shaped elongate members 133 may be equally spaced (e.g., equal to ⅛″ or more) in a longitudinal direction (e.g., from the first sidewall 126 to the second sidewall 128), and each of the number of “V”-shaped elongate members 133 may be fixedly attached (e.g., welded) or removably attached (for cleaning) to the grill understructure 134 at a number of positions. For example, each of the number of “V”-shaped elongate members 133 may include a first end attached to a position along a first longitudinal member 135a of the grill understructure 134 and a second end attached to a position along the second longitudinal member 135c (shown in FIG. 2C) of the grill understructure 134. Such a design for the “V”-shaped elongate members 133 allows a maximum heat flux from the grill firebox 114 through the grill 130 and/or grill surface 132 while simultaneously catching drippings in the drip pan 136 from grilling food to avoid flare-ups.

As illustrated in FIG. 2C, the grill understructure 134 may include, but is not limited to, a frame including a first longitudinal member 135a (see also FIGS. 2A and 2B) at the front of the grill unit 110 and a second longitudinal member 135c at the back of the grill unit 110. Each of the first longitudinal member 135a and the second longitudinal member 135c may extend from a position proximate to the first side of the grill unit 110 to a position proximate to the second side of the grill unit 110. The frame may further include a first latitudinal member 135b at the first side of the grill unit 110 and a second latitudinal member 135d (see also FIG. 2B) at the second side of the grill unit 110. Each of the first latitudinal member 135b and the second latitudinal member 135d may extend from a position proximate to the front of the grill unit 110 to a position proximate to the back of the grill unit 110.

To form the frame, a first end of the first longitudinal member 135a may be fixedly attached to a first end of the first latitudinal member 135b, a second end of the first latitudinal member 135b may be fixedly attached to a first end of the second longitudinal member 135c, a second end of the second longitudinal member 135c may be fixedly attached to a second end of the second latitudinal member 135d, and a first end of the second latitudinal member 135d may be fixedly attached to a second end of the first longitudinal member 135a. As provided herein, the first end of each of the number of “V”-shaped elongate members 133 may be attached to a position along the first longitudinal member 135a of the grill understructure 134 and the second end of each of the number of “V”-shaped elongate members 133 may be attached to a position along the second longitudinal member 135c of the grill understructure 134. Such a design for the frame allows a maximum heat flux from the grill firebox 114 through the frame to the grill surface 132.

The drip pan 136 may be removably attached (e.g., set on hooks, pins, screws, bolts, etc.) to the grill understructure 134 at the front of the grill unit 110 proximate to or under the first end of the number of “V”-shaped elongate members 133. Such a design allows easy access to the drippings from grilling food, which drippings may be used to baste the grilling food. And such a design also allows the drip pan 136 to be easily removed for cleaning.

The windlass 140, as shown in FIGS. 2A and 2B, may include, but is not limited to, a first vertical support 143a component and second vertical support 143b component, a horizontal support structure such as axle 145 component, a ratchet mechanism such as a ratchet wheel 146a component and a spring-loaded pawl 146b component, and a crank mechanism having a crank 148a component and a handle 148b component. The vertical support components 143a and 143b are configured to support the horizontal support structure and the ratchet mechanism. The crank mechanism is configured to turn the axle 145 component and wind one or more cables or chains 141 on the axle 145 or wind the one or more cables of chains 141 off the axle 145.

It is appreciated that more than two vertical supports may be used. For example, an n^{th} number of vertical supports may be used where n indicates the n^{th} vertical support. In one embodiment, the first vertical support 143a is positioned at a latitudinal midpoint of the first side of the grill unit 110 and the second vertical support 143b may be positioned at the latitudinal midpoint of the second side of the grill unit 110. According to one embodiment, the first vertical support 143a and the second vertical support 143b extend from a position proximate to a bottom of the grill firebox space 112b (e.g., the bottom 121 of the grill firebox 114) to a position above the sidewalls (e.g., the first sidewall 126 and the second sidewall 128) of the grill unit housing 120. The vertical support structure may be attached to the grill unit housing 120, for example, as illustrated in FIG. 2B by vertical support 143b attached to the bottom 121 of the grill firebox 114. It is appreciated that even though the vertical support structures re illustrated to be positioned inside the grill unit housing 120 for illustrative purposes only and are not intended to limit the scope of the embodiments. For example, the vertical supports may be positioned outside the grill unit housing 120 or a combination of inside and outside the grill unit housing by sandwiching the grill unit housing 120 between one or more vertical supports. Such a design provides the grill unit housing 120 and the vertical support structure with synergistic sturdiness.

The horizontal support structure such as the axle 145 may include a first end rotatably supported by the first vertical support 143a at the first side of the grill unit 110 and a second end rotatably supported by the second vertical support 143b at the second side of the grill unit 110. One or more cables or chains 141 may be attached to the first end of the axle 145 and the latitudinal midpoint of the grill 130, according to one embodiment, at the first side of the grill unit 110. The same cables or chains 141 or a different cables or chains (not shown) may be attached to the second end of the axle 145 and the latitudinal midpoint of the grill 130, according to one embodiment, at the second side of the grill unit 110. The length of the one or more cables or chains 141 may define the grill space 112a or the usable grill space 112a by raising or lowering the grill 130. For example, raising the grill using the cables 141 decreases the space associated with the grill space 112a while it increases the space associated with the grill firebox space 112b and vice versa.

The teeth of the gear wheel or ratchet wheel 146a are configured to engage spring-loaded pawl 146b. The ratchet wheel 146a may be fixedly attached to the axle 145 such that the ratchet wheel 146a rotates with the axle 145. The pawl 146b may be attached to the vertical support structures 143a and 143b, the grill unit housing 120, or a combination thereof in a position proximate to the ratchet wheel to engage the teeth of the ratchet wheel 146a. The pawl 146b may be configured to slide up and over the teeth of the ratchet wheel 146a while rotating the ratchet wheel 146a in a first direction corresponding to raising the grill 130. The pawl 146b may be further configured to lock between two of the teeth of the ratchet wheel 146a while rotating the ratchet wheel 146a in a second direction corresponding to lowering the grill 130, thereby locking the ratchet mechanism and the grill 130 at a particular height.

The crank 148a may be fixedly attached at a right angle to the axle 145, and the handle 148b may be fixedly attached at a right angle to the crank 148a, parallel to the axle 145. The crank mechanism may be configured to rotate the axle 145 in the first direction corresponding to raising the grill 130, winding the one or more cables or chains 141 on the axle 145. The crank mechanism may be further configured to rotate the axle 145 in the second direction corresponding to lowering the grill 130, winding the one or more cables or chains 141 off the axle 145. However, to rotate the axle 145 in the second direction corresponding to lowering the grill 130, the spring of the spring-loaded pawl 146b may need to be compressed to disengage the pawl 146b from the teeth of the ratchet wheel 146a.

In some embodiments, the ratchet mechanism and the crank mechanism of the windlass 140 may be replaced with control pulleys and one or more lift control cables or chains. The one or more lift control cables or chains may include a loop of the same one or more cables or chains 141 for winding on or off the axle 145.

In some embodiments, the windlass 140 may be replaced with a vertical support structure for the grill 130, wherein the vertical support structure includes a number of vertical supports (e.g., a first vertical support, a second vertical support, . . . , an n^{th} vertical support, wherein n indicates the n^{th} vertical support). For example, the vertical support structure may include, but is not limited to, a first vertical support at the first side and at the back of the grill unit 110 and a second vertical support at the second side and at the back of the grill unit 110. The number of vertical supports may have a sawtooth structure and the grill 130 may correspondingly have a cleat structure that interlocks with the sawtooth structure of the vertical supports, thereby providing a supporting mechanism for the grill 130. Alternatively, the number of vertical supports may have a tabbed structure and the grill 130 may interlock with the tabbed structure of the vertical supports, thereby providing a supporting mechanism for the grill 130. The grill 130 may be removably attached to the vertical support structure allowing the grill 130 to be removed for cleaning. Alternatively, the grill 130 may be attached to the vertical support structure with a spring-loaded mechanism allowing the grill 130 to be moved within the vertical support structure, for example, by lifting the grill 130 at the front of the grill unit 110 and sliding the grill up or down the vertical support structure at the back of the grill unit 110.

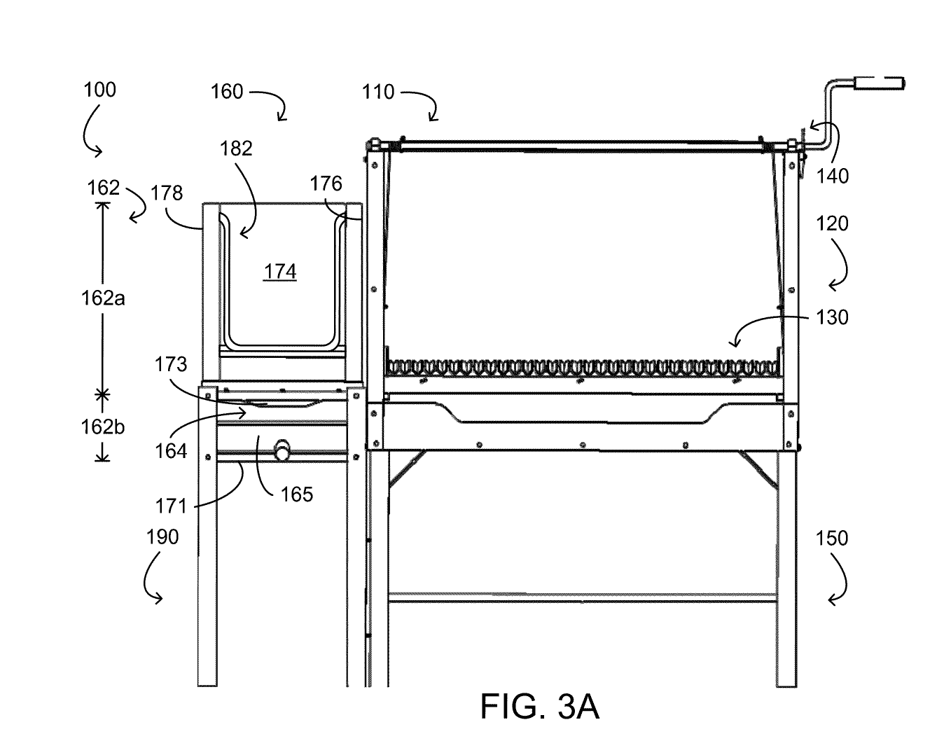

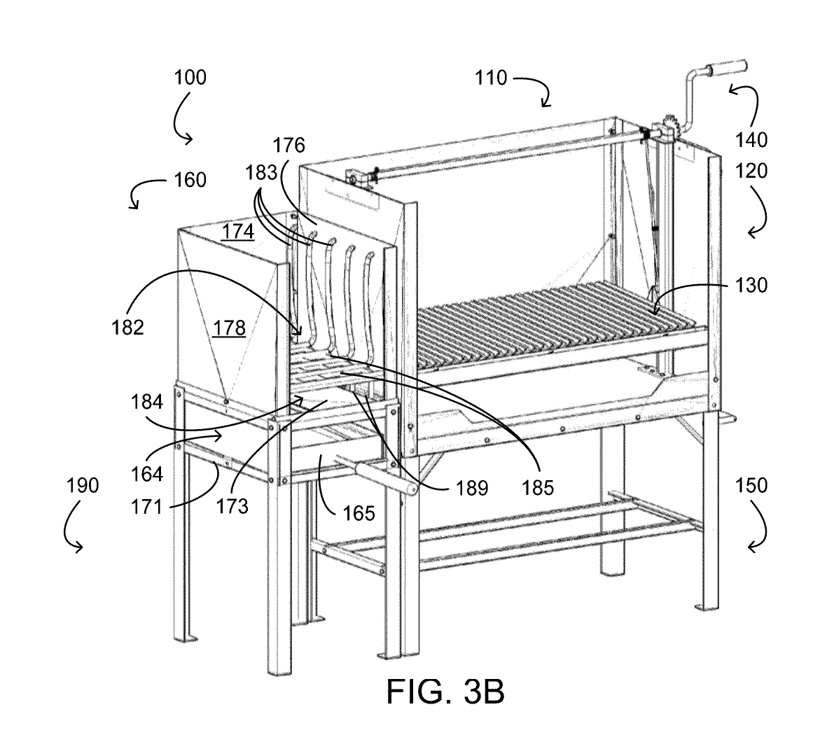

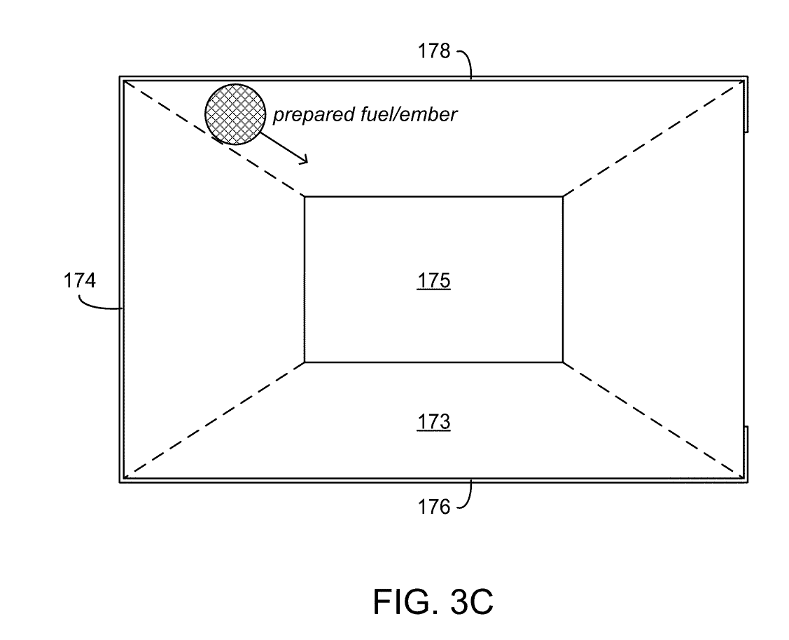

Referring now to FIGS. 3A and 3B, an apparatus including a fuel-preparing unit 160 in accordance with some embodiments are shown. As illustrated in FIGS. 3A and 3B, the fuel-preparing unit 160 may include a fuel-preparing unit support structure 190 configured to support the fuel-preparing unit 160. As illustrated in FIG. 3B, the fuel-preparing unit support structure 190 may include a set of legs. Any pair or pairs of legs may be cross-braced to reinforce the fuel-preparing unit support structure 190. Although the fuel-preparing unit 160 is illustrated to have a particular fuel-preparing unit support structure 190, the particular fuel-preparing unit support structure 190 illustrated in FIGS. 1, 2A, 2B, 3A, and 3B are not intended to be limiting. For example, the apparatus 100 may be configured to be portable or mobile, and the fuel-preparing unit 160 may include a fuel-preparing unit support structure 190 including wheels, runners, or the like. For another example, the apparatus 100 may be configured to be immobile or permanent, and the fuel-preparing unit 160 may include a fuel-preparing unit support structure 190 including a masonry unit or the like.

The fuel-preparing unit 160 may include a front that is closest to an operator while the operator customarily prepares fuel in the fuel-preparing unit 160. The fuel-preparing unit 160 may also include a back, wherein the back of the fuel-preparing unit 160 is opposite the front of the fuel-preparing unit 160 and/or farthest from the operator while the operator customarily prepares fuel in the fuel-preparing unit 160. The fuel-preparing unit 160 may also include a first side that is nominally the side of the fuel-preparing unit 160 to which the grill unit 110 is attached. The fuel-preparing unit 160 may also include a second side that is nominally the side of the fuel-preparing unit 160 opposite the first side of the fuel-preparing unit 160 and/or to which the grill unit 110 is not attached.

The fuel-preparing unit 160 may include a vertical space 162 partitioned into a fuel-preparing space 162a and a fuel-preparing unit firebox space 162b corresponding to a fuel-preparing unit firebox 164. The fuel-preparing space 162a may be reserved for a grate (e.g., the grate 180) and the fuel-preparing unit firebox space 162b may be reserved for prepared fuel (e.g., embers) and/or transfer of the prepared fuel.

The fuel-preparing unit housing 170 may include, but is not limited to, at least a bottom 171 that may coincide with a bottom of the fuel-preparing unit firebox 164. The fuel-preparing unit housing 170 may also include a front wall 172 (shown in FIGS. 4A-4E) that may cover a substantial portion of the fuel-preparing unit firebox space 162b or the entire fuel-preparing unit firebox space 162b at the front of the fuel-preparing unit 160 leaving the fuel-preparing space 162a open to the operator. For example, FIG. 4A illustrates the front wall 172 covering a substantial portion of the fuel-preparing unit firebox space 162b while allowing access to the fuel-preparing unit firebox 164 and/or contents thereof while safely containing the contents of the fuel-preparing unit firebox 164.

Referring back to FIGS. 3A and 3B, the fuel-preparing unit housing 170 may also include a back wall 174 that may cover the entire fuel-preparing unit firebox space 162b. The back wall 174 may also cover a substantial portion or the entire space of the fuel-preparing space 162a at the back of the fuel-preparing unit 160. The fuel-preparing unit housing 170 may also include a first sidewall 176 that may cover a substantial portion of the fuel-preparing unit firebox space 162b or the entire fuel-preparing unit firebox space 162b. For example, FIG. 4A illustrates the first sidewall 176 covering a substantial portion of the fuel-preparing unit firebox space 162b while opening 177 allows transfer of the prepared fuel directly to the grill firebox 114. The first sidewall 176 may also cover a substantial portion or the entire space of the fuel-preparing space 162a at the first side of the fuel-preparing unit 160. The fuel-preparing unit housing 170 may also include a second sidewall 178 that may cover a substantial portion or the entire space of the fuel-preparing unit firebox space 162b. The second sidewall 178 may also cover a substantial portion of the fuel-preparing space 162a or the entire fuel-preparing space 162a at the second side of the fuel-preparing unit 160. Leaving the fuel-preparing space 162a open at the front of the fuel-preparing unit 160 and closing the fuel-preparing space 162a off elsewhere allows easy access to the fuel-preparing space 162a while a) reducing or eliminating environmental factors such as wind, which may otherwise lead to convective heat loss from the fuel-preparing space 162a; b) radiating heat back into the fuel-preparing space 162a, which may establish a spatial and/or temporal thermal equilibrium in the fuel-preparing space 162a; and/or c) protecting non-operators or passersby.

In some embodiments, the fuel-preparing unit housing 170, including one or more of the bottom 171, the front wall 172 (if present), the back wall 174, the first sidewall 176, and the second sidewall 128, may be adjustable such that the size of the fuel-preparing unit housing 170 may be adjusted to one or more predetermined sizes. For example, in some embodiments, the back wall 174, the first sidewall 176, and the second sidewall 178 may each include two or more interleaved panels with interlocking tabs and slots at predetermined positions for adjusting the height of the back wall 174, the first sidewall 176, and the second sidewall 178 to the one or more predetermined sizes. For example, in some embodiments, the bottom 171, the front wall 172, the back wall 174, the first sidewall 176, and the second sidewall 178, may each include two or more interleaved panels with interlocking tabs and slots at predetermined positions for adjusting the bottom 171, the front wall 172, the back wall 174, the first sidewall 176, and the second sidewall 178 in a longitudinal and/or latitudinal dimension to the one or more predetermined sizes. Grates (e.g., the grate 180) of predetermined sizes may be used in accordance with the foregoing predetermined sizes of the fuel-preparing unit housing 170.

The grate 180 may include, but is not limited to, a grate surface 182 and a grate understructure 184, wherein the grate surface 182 may be fixedly attached (e.g., welded) to the grate understructure 184. The grate surface 182 may include, but is not limited to, a number of “U”-shaped members 183 configured to a) retain heat (e.g., iron, such as wrought iron or cast iron; steel, such as stainless steel; etc.); b) resist rust (e.g., rust-preventing coating on iron; stainless steel; etc.); and/or physically separate prepared fuel from fuel being prepared. Each of the number of “U”-shaped members 183 may be equally spaced apart (e.g., equal to 4″ or more) in a longitudinal direction (e.g., from the front of the fuel-preparing unit 160 to the back of the fuel-preparing unit 160). It is appreciated that each of the number of “U”-shaped members 183 may be fixedly attached (e.g., welded) to the grate understructure 184 at a number of positions. For example, each of the number of “U”-shaped members 183 may include a bottom attached to a position along longitudinal members 185 of the grate understructure 184. Such a design for the “U”-shaped members 183 allows maximum air circulation in and around the grate surface 182, thereby providing maximum oxygen for the fuel being prepared.

According to one embodiment, each of the longitudinal members 185 extends from a position proximate to the front of the fuel-preparing unit 160 to a position proximate to the back of the fuel-preparing unit 160. The grate understructure 184 may also include, but is not limited to, a number of latitudinal members (not shown) where each of the latitudinal members 186 extends from a position proximate to the first side of the fuel-preparing unit 160 to a position proximate to the second side of the fuel-preparing unit 160. As provided herein, each of the number of “U”-shaped members 183 may include a bottom attached to a position along the longitudinal members 185 of the grate understructure 184. Such a design for the longitudinal members 185 allows maximum air circulation in and around the grate understructure 184, thereby providing maximum oxygen for the fuel being prepared.

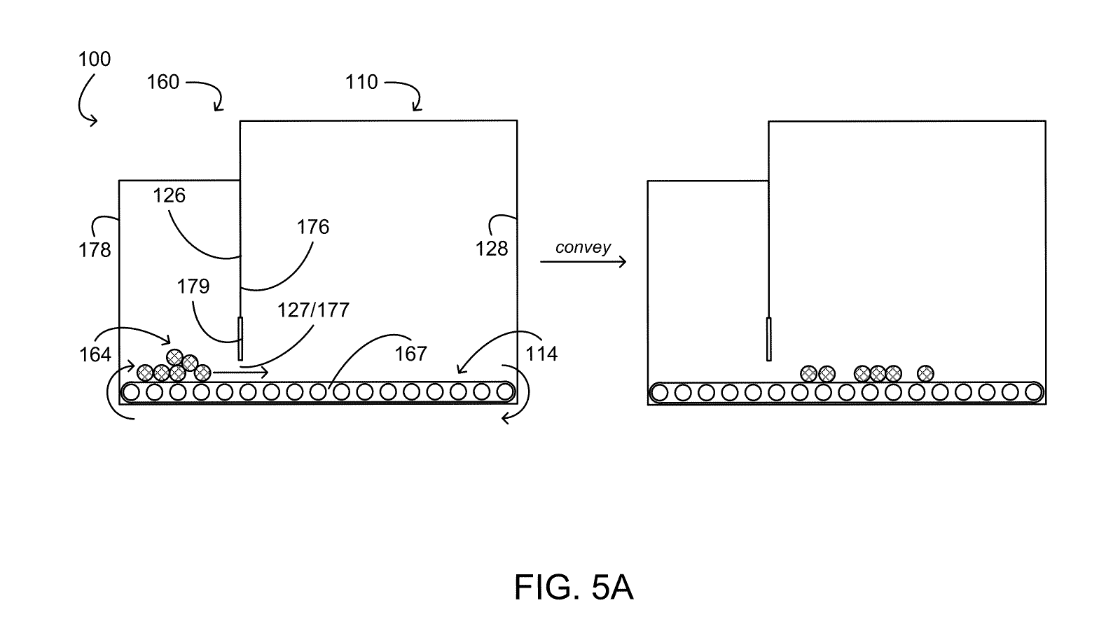

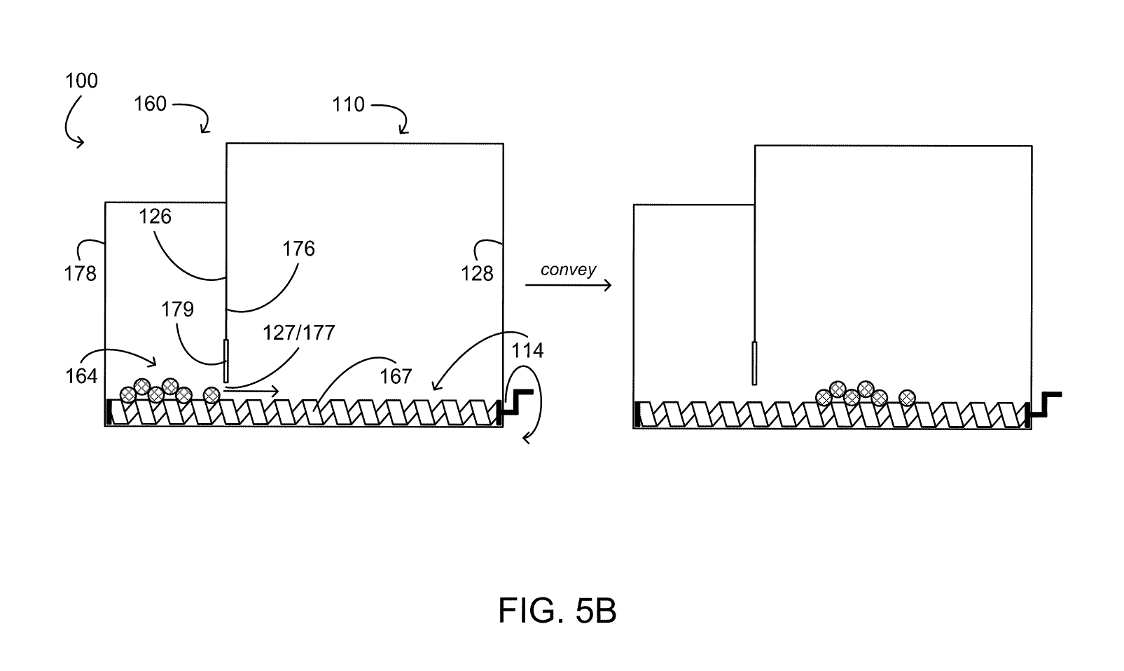

The grate 180 may be supported by a grate support structure, e.g., set of legs 189 fixedly attached to the grate understructure 184 or otherwise a part thereof. The set of legs 189 may include four legs where any pair or pairs of legs 189 may be cross-braced to reinforce the grate support structure. The grate 180 is positioned atop the grate support structure and may optionally be integrated within. The grate 180 may freely stand within the fuel-preparing unit housing 170, or the grate 180 may be secured to the fuel-preparing unit housing 170. The grate support structure may be further configured to accommodate a shovel 165 or a conveyor 167 (see FIGS. 5A and 5B) in the fuel-preparing unit firebox space 162b under the grate support structure for transferring the prepared fuel from the fuel-preparing unit 160 to the grill unit 110.

The grate 180 may alternatively be supported by a grate support structure (not shown) where the grate 180 is suspended from the fuel-preparing unit housing 170 or a component therein. The grate 180 may freely suspend from the fuel-preparing unit housing 170, or the grate 180 may be secured to the fuel-preparing unit housing 170. The grate support structure may be further configured to accommodate a shovel 165 or a conveyor 167 (see FIGS. 5A and 5B) in the fuel-preparing unit firebox space 162b under the grate support structure 188 for transferring the prepared fuel.

In some embodiments, the grate support structure may include a set of bricks (e.g., firebricks) at the bottom 171 of the fuel-preparing unit firebox 164 configured to support the grate 180. The set of bricks may be further configured to form an insulated well under the grate 180 for temporary storage of the prepared fuel prior to transferring the prepared fuel to the grill firebox 114. Indeed, bricks such as firebricks may be utilized to insulate any portion of the fuel-preparing unit firebox 164 or grill firebox 114.

It is appreciated that in some embodiments, the grate support structure may include a physical partition 173 secured to the fuel-preparing unit housing 170 that physically partitions the vertical space 162 into the fuel-preparing space 162a and the fuel-preparing unit firebox space 162b corresponding to the fuel-preparing unit firebox 164. The physical partition 173 secured to the fuel-preparing unit housing 170 physically partitions the vertical space 162 into the fuel-preparing space 162a and the fuel-preparing unit firebox space 162b. The physical partition 173 may include a chute for prepared fuel including a downward slope from the fuel-preparing unit housing 170 to a central opening 175 (shown in FIG. 3C) in the physical partition 173, through which central opening 175 the prepared fuel may drop from the grate 180 to a center of the fuel-preparing unit firebox 164, optionally onto a shovel 165 or a conveyor 167 (see FIGS. 5A and 5B) in the fuel-preparing unit firebox space 162b.

Referring now to FIG. 3C, the physical partition 173 including the chute with the downward slope from the fuel-preparing unit housing 170 to the central opening 175 is shown. The prepared fuel is transiently located on the physical partition 173 prior to dropping through the central opening 175 to the center of the fuel-preparing unit firebox 164, optionally onto the shovel 165 or the conveyor 167 (see FIGS. 5A and 5B) in the fuel-preparing unit firebox space 162b. Such a design allows prepared fuel to be aggregated in a center of the fuel-preparing unit firebox 164, in a center of a shovel 165 placed in the fuel-preparing unit firebox 164. The prepared fuel may subsequently be transferred from the fuel preparing unit firebox 164 to the grill firebox 114 using the shovel 165, or in a conveyor-loading center of a conveyor 167 (see FIGS. 5A and 5B).

Referring now to FIGS. 3A-3C, each end or terminus of the number of “U”-shaped members 183 of the grate surface 182 may terminate in a curved or bent structure (e.g., hook) configured to overhang the first side 176 or the second side 178 of the fuel-preparing unit housing 170, according to some embodiments. It is appreciated that in some embodiments, each end or terminus of the number of “U”-shaped members 183 of the grate surface 182 may terminate in a curved or bent structure (e.g., hook) configured to hang on longitudinal projections or ledges. The longitudinal projections or ledges may be stamped into the first and second sides of the fuel-preparing unit housing 170 or attached to the first and second sides of the fuel-preparing unit housing 170.

Referring now to FIGS. 4A-4E, apparatuses in accordance with some embodiments having a fuel transfer mechanism between the grill unit 110 and the fuel-preparing unit 160 are shown. The fuel-preparing unit firebox 164 may include a physical partition 173 secured to the fuel-preparing unit housing 170 that physically partitions or bisects the fuel-preparing unit firebox space 162b. The physical partition 173 may include a chute for prepared fuel including a downward slope from the second sidewall 178 of fuel-preparing unit housing 170 to an opening 127/177 in the first sidewall 176 of the fuel-preparing unit housing 170 and the first sidewall 126 of the grill unit housing 120, through which opening 127/177 the prepared fuel may drop from the grate 180 to a side of the grill firebox 114.

The physical partition 173 including the chute with the downward slope from the second sidewall 178 of fuel-preparing unit housing 170 to an opening 127/177 in the first sidewall 176 of the fuel-preparing unit housing 170 and the first sidewall 126 of the grill unit housing 120. The prepared fuel is transiently located on the physical partition 173 prior to dropping through the central opening 127/177 to a side of the grill firebox 114. Such a design allows the prepared fuel to be directly delivered to the grill firebox 114 and/or aggregated in a side of the grill firebox 114 such that the prepared fuel need not be transferred by hand (e.g., by shovel) between the fuel-preparing unit firebox 164 and the grill firebox 114, only moved within the grill firebox 114 as desired for different heat zones.

Referring now to FIG. 4B, the physical partition 173 includes the chute with the downward slope from the second sidewall 178 of fuel-preparing unit housing 170 to an opening 127/177 in the first sidewall 126 of the grill unit housing 120 and/or the first sidewall 176 of the fuel-preparing unit housing 170. The prepared fuel is located on the physical partition 173 behind a door 179 (with optional handle attached thereto) over the central opening 127/177. The door 179 may be opened by sliding the door 179 up from the bottom 121/171 of the grill firebox 114 and/or fuel-preparing unit firebox 164 (as shown). In one embodiment, the door 179 may be opened by sliding it toward an operator customarily cooking on the grill unit 110 and/or away from the back of the grill unit 110 and/or fuel-preparing unit 160. According to one embodiment, the door 179 may be detachable and removable by completely sliding the door 179 away from the back of the grill unit 110 and/or fuel-preparing unit 160. Opening the door 179 releases the prepared fuel from the fuel-preparing unit firebox 164, dropping the prepared fuel through the opening 127/177 and into the grill firebox 114.

In embodiments including a detachable door 179, the door 179 may be used as a shovel or the like to redistribute the prepared fuel in the grill firebox 114. Such a design allows the prepared fuel to be directly delivered to the grill firebox 114 and/or aggregated in a side of the grill firebox 114 such that the prepared fuel need not be transferred by hand (e.g., by shovel) between the fuel-preparing unit firebox 164 and the grill firebox 114, only moved within the grill firebox 114 as desired for different heat zones. For example, according to one exemplary embodiment illustrated in FIG. 4C, the door 179 may slide horizontally across the grill firebox 114 over railings attached to the grill unit housing in order to redistribute the prepared fuel in the grill firebox 114. The door 179 may be attached to the railings by a hinge that allows the door 179 to swing toward and/or away from the first sidewall 126 of the grill housing 120 as shown in FIG. 4C. The hinge further allows the door 179 to slide horizontally back across the grill firebox 114 to its original position without disturbing the prepared fuel. However, if desired, the hinge may further allow the door 179 itself to be used to further redistribute the prepared fuel.

Referring now to FIGS. 4D and 4E, the physical partition 173 including the chute with the downward slope from the second sidewall 178 of fuel-preparing unit housing 170 to an opening 127/177 in the first sidewall 126 of the grill unit housing 120 and/or the first sidewall 176 of the fuel-preparing unit housing 170 is shown. The prepared fuel is located on the physical partition 173 behind a door 179 (with optional handle attached thereto) over the central opening 127/177. As illustrated, a bottom of the door 179 may be attached to a top of the bottom 121 of the grill unit housing 120 by a pair of posts. It is appreciated that while in this illustrative embodiment a pair of posts is used the embodiments are not limited thereto and any number of posts may be used. In this illustrative embodiment, a first post may be located at the front of the grill unit 110 and/or fuel-preparing unit 160 and the other post may be located at the back of the grill unit 110 and/or fuel-preparing unit 160. As further illustrated, the door 179 may be opened by sliding the bottom 121 of the grill unit housing 120 into a predetermined angled position(s) pushing the posts and therefore the door 179 upward, thereby creating an opening for the prepared fuel to be transferred from the fuel-preparing unit 160 to the grill firebox 114.

In one embodiment, sliding the bottom 121 of the grill unit housing 120 completes the chute with a downward slope from the second sidewall 178 of fuel-preparing unit housing 170 through the opening 127/177 to the second sidewall 128 of the grill unit housing 120. As such, opening the door 179 releases the prepared fuel from the fuel-preparing unit firebox 164, dropping the prepared fuel through the opening 127/177 and into the grill firebox 114. Such a design allows the prepared fuel to be directly delivered to the grill firebox 114 and/or aggregated in a side of the grill firebox 114 such that the prepared fuel need not be transferred by hand (e.g., by shovel) between the fuel-preparing unit firebox 164 and the grill firebox 114, only moved within the grill firebox 114 as desired for different heat zones.

Referring now to FIGS. 5A and 5B, an apparatus including a conveyor for transferring fuel according to one embodiment is shown. The fuel-preparing unit firebox 164 may include a conveyor 167 for transferring prepared fuel between the fuel-preparing unit firebox 164 and the grill firebox 114 through an opening 127/177 in the first sidewall 126 of the grill unit housing 120 and/or the first sidewall 176 of the fuel-preparing unit housing 170. The opening 127/177 may be optionally covered with a door 179, as described herein. The conveyor 167 may be a belt-type conveyor, which belt-type conveyor may be manually cranked by a crank mechanism (not shown) to transfer the prepared fuel between the fuel-preparing unit firebox 164 and the grill firebox 114 through the opening 127/177. The conveyor 167 may be an auger-type conveyor (shown in FIG. 5B), which may be manually cranked by a crank mechanism to transfer the prepared fuel between the fuel-preparing unit firebox 164 and the grill firebox 114 through the opening 127/177. Such a design allows the prepared fuel to be directly delivered to the grill firebox 114 and/or aggregated in a side of the grill firebox 114 such that the prepared fuel need not be transferred by hand (e.g., by shovel) between the fuel-preparing unit firebox 164 and the grill firebox 114, only moved within the grill firebox 114 as desired for different heat zones.

Various embodiments are described with respect to a chute with downward slope. However, it is appreciated that the downward structure of the chute is exemplary and not intended to limit the scope of the embodiments. For example, the chute may by horizontal.

As such, provided herein is an apparatus comprising, a grill unit for grilling food, wherein the grill unit comprises a grill firebox and a height-adjustable grill positioned over the grill firebox; and an ember-preparing unit for preparing embers, wherein the ember-preparing unit comprises a chute configured to aggregate embers for the grill firebox, and wherein the ember-preparing unit is removably attached outboard of the grill unit. In some embodiments, the ember-preparing unit further comprises an ember-preparing unit firebox configured to collect the embers, and the chute is configured to aggregate the embers in a center of the ember-preparing unit firebox. In some embodiments, the ember-preparing unit firebox is configured to accommodate a shovel, and the chute is further configured to aggregate the embers in a center of the shovel. In some embodiments, the grill firebox comprises an opening, and the chute is configured to aggregate and transfer the embers from the ember-preparing unit to the grill firebox through the opening. In some embodiments, the apparatus further comprises a windlass configured to raise or lower the grill over the grill firebox to change a height associated with the grill and the grill firebox. In some embodiments, the windlass comprises an axle; a first cable attached to a first end of the axle and a first end of the height adjustable grill; and a second cable attached to a second end of the axle and a second end of the height adjustable grill, wherein the axle is configured to wind the first cable and the second cable on and off the axle. In some embodiments, the windlass comprises a ratchet mechanism configured to lock the height adjustable grill a height over the grill firebox.

Also provided herein is an apparatus comprising a grill unit for grilling food comprising a grill firebox and a grill positioned above the grill firebox; an ember-preparing unit for preparing embers comprising a chute configured to aggregate and transfer embers to the grill firebox, wherein the ember-preparing unit is removably attached outboard of the grill unit; and a windlass configured to raise or lower the grill over the grill firebox to change a height associated with the grill and the grill firebox. In some embodiments, the ember-preparing unit further comprises an ember-preparing unit firebox configured to collect the embers, wherein the chute is configured to aggregate the embers in a center of the ember-preparing unit firebox. In some embodiments, the ember-preparing unit firebox is configured to accommodate a shovel, and the chute is further configured to aggregate the embers in a center of the shovel. In some embodiments, the grill firebox comprises an opening, and the chute is configured to aggregate and transfer the embers from the ember-preparing unit to the grill firebox through the opening. In some embodiments, the grill comprises a plurality of “V”-shaped elongate members configured to convey drippings from grilling food to a drip pan. In some embodiments, the apparatus is portable.

Also provided herein is an apparatus comprising a grill unit for cooking food comprising a grill firebox and a grill positioned substantially over the grill firebox; and a fuel-preparing unit for preparing fuel comprising a chute configured to aggregate and transfer prepared fuel to the grill firebox, wherein the fuel-preparing unit is removably attached outboard of the grill unit. In some embodiments, the fuel-preparing unit further comprises a fuel-preparing unit firebox configured to collect the prepared fuel, wherein the chute is configured to aggregate the prepared fuel in a center of the fuel-preparing unit firebox. In some embodiments, the fuel-preparing unit firebox is configured to accommodate a shovel, and the chute is further configured to aggregate the prepared fuel in a center of the shovel. In some embodiments, the grill firebox comprises an opening, and the chute is configured to aggregate and transfer the prepared fuel from the fuel-preparing unit to the grill firebox through the opening. In some embodiments, the prepared fuel comprises embers derived from a fuel source selected from a group consisting of wood, lump charcoal, charcoal briquettes, and extruded charcoal. In some embodiments, the grill comprises a plurality of “V”-shaped elongate members configured to convey drippings from grilling food to a drip pan. In some embodiments, the plurality of “V”-shaped elongate members comprise stainless steel or iron.

Also provided herein is an apparatus comprising a fuel-preparing unit for preparing fuel comprising a chute configured to aggregate and transfer prepared fuel to a grill unit for grilling food removably attached outboard of the fuel-preparing unit. In some embodiments, the fuel-preparing unit further comprises a fuel-preparing unit firebox configured to collect the prepared fuel, and the chute is configured to aggregate the prepared fuel in a center of the fuel-preparing unit firebox. In some embodiments, the fuel-preparing unit firebox is configured to accommodate a shovel, and the chute is further configured to aggregate the prepared fuel in a center of the shovel. In some embodiments, the grill unit comprises a grill firebox comprising an opening, and the chute is configured to aggregate and transfer the prepared fuel from the fuel-preparing unit to the grill firebox through the opening. In some embodiments, the prepared fuel comprises embers derived from a fuel source selected from a group consisting of wood, lump charcoal, charcoal briquettes, and extruded charcoal.

While some particular embodiments have been illustrated and/or described herein, and while the particular embodiments have been illustrated and/or described in some detail, it is not the intention of the applicant(s) for the particular embodiments to limit the scope of the claimed invention. Additional adaptations and/or modifications may readily appear to persons having ordinary skill in the art, and, in broader aspects, these adaptations and/or modifications may be encompassed by the embodiments as well. Accordingly, departures may be made from the particular embodiments illustrated and/or described herein without departing from the scope of the claimed invention.

What is claimed is:

1. An apparatus comprising:
a grill unit for grilling food, wherein the grill unit comprises a grill firebox and a height-adjustable grill positioned over the grill firebox; and
an ember-preparing unit for preparing embers, wherein the ember-preparing unit comprises a chute configured to aggregate embers for the grill firebox, and wherein the ember-preparing unit is removably attached outboard of the grill unit.

2. The apparatus of claim 1, wherein the ember-preparing unit further comprises an ember-preparing unit firebox configured to collect the embers, and wherein the chute is configured to aggregate the embers in a center of the ember-preparing unit firebox.

3. The apparatus of claim 2, wherein the ember-preparing unit firebox is configured to accommodate a shovel, and wherein the chute is further configured to aggregate the embers in a center of the shovel.

4. The apparatus of claim 1, wherein the grill firebox comprises an opening, and wherein the chute is configured to aggregate and transfer the embers from the ember-preparing unit to the grill firebox through the opening.

5. The apparatus of claim 1 further comprising a windlass configured to raise or lower the grill over the grill firebox to change a height associated with the grill and the grill firebox.

6. The apparatus of claim 5, wherein the windlass comprises:
an axle;
a first cable attached to a first end of the axle and a first end of the height adjustable grill; and
a second cable attached to a second end of the axle and a second end of the height adjustable grill,
wherein the axle is configured to wind the first cable and the second cable on and off the axle.

7. The apparatus of claim 5, wherein the windlass comprises a ratchet mechanism configured to lock the height adjustable grill a height over the grill firebox.

8. An apparatus comprising:
a grill unit for grilling food comprising a grill firebox and a grill positioned above the grill firebox;
an ember-preparing unit for preparing embers comprising a chute configured to aggregate and transfer embers to the grill firebox, wherein the ember-preparing unit is removably attached outboard of the grill unit; and
a windlass configured to raise or lower the grill over the grill firebox to change a height associated with the grill and the grill firebox.

9. The apparatus of claim 8, wherein the ember-preparing unit further comprises an ember-preparing unit firebox configured to collect the embers, and wherein the chute is configured to aggregate the embers in a center of the ember-preparing unit firebox.

10. The apparatus of claim 9, wherein the ember-preparing unit firebox is configured to accommodate a shovel, and wherein the chute is further configured to aggregate the embers in a center of the shovel.

11. The apparatus of claim 8, wherein the grill firebox comprises an opening, and wherein the chute is configured to aggregate and transfer the embers from the ember-preparing unit to the grill firebox through the opening.

12. The apparatus of claim 8, wherein the grill comprises a plurality of “V”-shaped elongate members configured to convey drippings from grilling food to a drip pan.

13. The apparatus of claim 8, wherein the apparatus is portable.

14. An apparatus comprising:
a grill unit for cooking food comprising a grill firebox and a grill positioned substantially over the grill firebox; and
a fuel-preparing unit for preparing fuel comprising a chute configured to aggregate and transfer prepared fuel to the grill firebox, wherein the fuel-preparing unit is removably attached outboard of the grill unit.

15. The apparatus of claim 14, wherein the fuel-preparing unit further comprises a fuel-preparing unit firebox configured to collect the prepared fuel, and wherein the chute is configured to aggregate the prepared fuel in a center of the fuel-preparing unit firebox.

16. The apparatus of claim 15, wherein the fuel-preparing unit firebox is configured to accommodate a shovel, and wherein the chute is further configured to aggregate the prepared fuel in a center of the shovel.

17. The apparatus of claim 14, wherein the grill firebox comprises an opening, and wherein the chute is configured to aggregate and transfer the prepared fuel from the fuel-preparing unit to the grill firebox through the opening.

18. The apparatus of claim 14, wherein the prepared fuel comprises embers derived from a fuel source selected from a group consisting of wood, lump charcoal, charcoal briquettes, and extruded charcoal.

19. The apparatus of claim 14, wherein the grill comprises a plurality of “V”-shaped elongate members configured to convey drippings from grilling food to a drip pan.

20. The apparatus of claim 19, wherein the plurality of “V”-shaped elongate members comprise stainless steel or iron.

21. An apparatus comprising:
a fuel-preparing unit for preparing fuel comprising a chute configured to aggregate and transfer prepared fuel to a grill unit for grilling food removably attached outboard of the fuel-preparing unit.

22. The apparatus of claim 21, wherein the fuel-preparing unit further comprises a fuel-preparing unit firebox configured to collect the prepared fuel, and wherein the chute is configured to aggregate the prepared fuel in a center of the fuel-preparing unit firebox.

23. The apparatus of claim 22, wherein the fuel-preparing unit firebox is configured to accommodate a shovel, and wherein the chute is further configured to aggregate the prepared fuel in a center of the shovel.

24. The apparatus of claim 21, wherein the grill unit comprises a grill firebox comprising an opening, and wherein the chute is configured to aggregate and transfer the prepared fuel from the fuel-preparing unit to the grill firebox through the opening.

25. The apparatus of claim 21, wherein the prepared fuel comprises embers derived from a fuel source selected from a group consisting of wood, lump charcoal, charcoal briquettes, and extruded charcoal.
